(19) United States
(12) Patent Application Publication
(10) Pub. No.: US 2016/0171117 A1
(43) Pub. Date: Jun. 16, 2016

(54) PROCEDURE TO SIMPLIFY THE ADMINISTRATION AND HANDLING OF IDENTIFICATION CARDS

(71) Applicant: GlobalKey AG, St. Gallen (CH)

(72) Inventors: Bernd BARTA, Au/SG (CH); Kyriaki EFSTATHIOU, Horbranz (CH); Andrea M. HELBOK, Horbranz (CH); Johannes LIPPERT, Wolfgang (CH); Otmar PRANTL, Salzburg (AT)

(73) Assignee: GlobalKey AG, St. Gallen (CH)

(21) Appl. No.: 14/965,066

(22) Filed: Dec. 10, 2015

(30) Foreign Application Priority Data
Dec. 10, 2014 (DE) DE102014118373.8

(51) Int. Cl. G06F 17/30; G06K 7/10

(52) U.S. Cl. CPC G06F 17/30876; G06K 7/10297

(57) ABSTRACT

To simplify the administration and handling of several companies' ID cards granting entitlements, containing the personified data of the respective user, a web platform is intended which communicates with the companies. For this, the points of acceptance for the cards are equipped with reading devices to read RFID and/or NFC data carriers. For this, the user obtains a visually readable unique identification number (UIN) and a data carrier readable with RFID and/or NFC reading devices containing a UIN which is uniquely linked with the visually readable UIN. On the web platform the user opens an account under the visible UIN and enters the company denomination and the card data into the account. The UIN of the data carrier will be included in the respective company's authentication system and transferred to the reading device(s) for the reading of RFID or NFC data carriers and linked with the entitlements granted by the card.

### FIELD OF THE INVENTION

The invention relates to identification (ID) cards used in consumer commercial transactions. The invention provides a procedure to simplify the administration and handling of ID cards of several companies, with which the users are granted an entitlement.

### BACKGROUND OF THE INVENTION

Nowadays, most people are showered with all sorts of cards from a large number of companies, given away, for example, as company, membership, club, entrance and access control cards or as vouchers. The use of these many cards causes significant problems, for one due to the space required for all these cards and then finding the right card when it is needed in the shop or whatever point of acceptance. This leads to the user often only carrying some of the cards, thus restricting or totally preventing the use of the other cards.

Furthermore, the administration, production and distribution of the cards are very expensive, especially as they often have an expiration date, i.e. they must be renewed before they expire.

Accordingly, there is a need to avoid the problems the user has when handling many different cards and to significantly reduce the costs the companies have for cards. The present invention satisfied this need.

### SUMMARY OF THE INVENTION

One aspect of the invention features a procedure to simplify the administration and handling of several companies' ID cards granting entitlements, containing the personified data of the respective user, through a web platform which communicates with the companies for this, the points of acceptance for the cards are equipped with reading devices to read RFID and/or NFC data carriers, involving the following steps:
The user obtains a visually readable unique user identification number (UIN) and at least one data carrier readable with RFID and/or NFC reading devices containing a data carrier identification number (UIN) which is uniquely linked on the web platform with the visually readable user identification number (UIN),
on the web platform the user opens an account under the visually readable user identification number (UIN) and enters the company denomination and the card data into the account,
through the web platform the company in question will be notified of the user's data carrier identification number (UIN),
the user's data carrier identification number (UIN) will be included in the respective company's authentication system and transferred to the respective company's reading device(s) for the reading of RFID or NFC data carriers and linked with the entitlements granted by the card.

In certain embodiments, the visually readable user identification number (UIN) is uniquely linked on the web platform with two or more data carriers that can be read with RFID and/or NFC reading devices. The two or more data carriers typically grant different entitlements to the user.

In other embodiments, at least one data carrier readable with RFID and/or NFC is connected to an object the user carries with him (“him” includes “her”). The object connected to the RFID and/or NFC data carrier is the user's mobile phone or key ring. For instance, the mobile phone's protective cover is equipped with the data carrier and/or the data carrier is fixed to the mobile phone shell.

In the embodiments described above, the user can obtain the visually readable identification number (UIN) with a cover preventing third parties from seeing it.

In certain embodiments, the point of acceptance has at least one register (also referred to herein as a “cash register” or “till”) equipped as a reading device to read RFID and/or NFC data carriers.

In certain embodiments, the reading device to read RFID and/or NFC data carriers comprises at least one mobile phone of the point of acceptance.

In embodiments of the method described above, the user can apply for another company's card with his visually readable user identification number (UIN) and his account at the web platform, and that the web platform notifies the other company of the user's data carrier identification number(s) (UIN) uniquely linked with the visually readable identification number (UIN).

Other features and advantages of the present invention will be understood by reference to the detailed description that follows.

### DETAILED DESCRIPTION OF ILLUSTRATIVE EMBODIMENTS

The present invention provides procedures to simplify the administration and handling of ID cards of several companies, with which the users are granted an entitlement.

The ID cards whose administration and handling is simplified can be, for example, customer cards, credit cards, membership cards, discount cards, access cards and other cards, granting the user an entitlement or an advantage especially with respect to goods or services.

The company can be a firm, an association, but also any other private or public facility. The entitlement or advantage can be, for example, a free or reduced admission, a discount, points for purchases or another advantage.

The invention is practiced through a web platform which communicates with the companies. For this, the points of acceptance must be equipped with reading devices containing RFID (Radio Frequency Identification) and/or NFC (Near Field Communication) technology. The points of acceptance can be located at the entrance or access to an establishment, for example a shop or sports facility, or at the till or tills of such an establishment.

This involves the following steps:

The user receives a visually readable unique identification number (Unique Identification Number, short “UIN”), for example in the form of a combination of numbers and/or letters allowing to clearly identify the card.

With this identification number, hereafter also referred to as UIN, the user can log into the web platform.

When appearing for the user, the visually readable UIN will preferably be hidden under a cover to avoid third parties seeing it. The cover can be, for instance, a non-transparent, removable adhesive film on a cardboard or plastic surface, containing the UIN.

Furthermore, the user obtains a data carrier, for example a transponder, readable with standardized RFID (Radio Frequency Identification) reading devices or standardized NFC (Near Field Communication) reading devices, preferably according to ISO 14443 or ISO 15693.

The data carrier contains a data carrier UIN with which the data carrier can be clearly identified and which is uniquely linked with the user's visually readable UIN on the web platform.

The visible user UIN and the UIN on the data carrier can be one and the same, but the visible user UIN and the UIN on the data carrier can also be different.

It is also possible to uniquely link two or more data carriers with the visually readable user UIN on the web platform. In this case, the data carriers can have the same data carrier UIN or differing data carrier UINs.

With the two or more data carriers different entitlements can be granted, for example, access authorizations or entitlements for credit cards.

The data carrier will preferably be connected to an object the user is carries with him. A mobile phone would be particularly suitable. However, this object can also be a key ring, an item of clothing, a purse, a wallet or a spectacle case, for example.

In case of the mobile phone the protective cover can be the object with the data carrier. However, the data carrier can also be fixed to the mobile phone shell, stuck to it for example, preferably on the back of the shell, for instance embedded into a coating, cushion or pad.

If according to the present invention the data carrier is used in combination with a mobile phone, another advantage consists in the fact that the mobile phone can be used when it is switched on as well as when it is switched off. Besides, the personalized UIN is not visible to non-users.

To implement the procedure according to this invention the user opens an account on the web platform under this UIN, into which he enters the company denomination, i.e. the name of the firm, association or the private or public facility in question as well as the respective card data, i.e. the name of the user, card number, expiration date etc.

Through the web platform the cooperating and communicating companies receive the user's data carrier UIN and in the process this UIN is transferred to the company's RFID and/or NFC reading devices at the points of acceptance and linked to the entitlement or advantage granted with the card.

This means that the company has the possibility to verify the card and carry out the next steps regarding the advantages and entitlements granted by the card, such as access, discount, points for a purchase etc.

For this purpose, the till or tills of the point of acceptance can be used as RFID and/or NFC reading devices or they can be equipped with them.

The RFID and/or NFC reading device can also exist in the form of a mobile phone suitable for reading RFID and/or NFC data carriers; in this case there would be no extra costs for additionally installed fixed reading devices.

If the company is a sports club with fan shops, for example, and the fan shops are the points of acceptance, then a shop employee's mobile phone, for instance, can be used as reading device. The procedure according to the invention can therefore also be used in merchandising, for example.

According to the procedure conceived by the invention, with his account on the web platform and his UIN, the user can also apply for cards of other companies cooperating with the web platform.

With the procedure according to the invention a large number of cards can be replaced by a single UIN. It is understood that credit cards are also part of the cards that can be replaced.

With his UIN and his web platform account, the user can also book, for example, an access authorization for a cooperating company's facility, for example for a football game taking place in the cooperating company's stadium, whose entrance or entrances are equipped with an access control system such as a turnstile with reading devices to read RFID and/or NFC data carriers. By making the booking the access will be granted.

Another advantage is the possibility for the user to add further cards to his account as well to change cards through his web platform account.

Furthermore, forwarding applications for cards to companies cooperating and communicating with the web platform is greatly simplified, as well as forwarding an updated UIN after the user has released it, for example, if the data carrier is lost or replaced.

In addition, the procedure according to the invention greatly simplifies administration, because there is no need for the company cooperating with the web platform to issue and deliver the cards or to extend their validity.

The present invention is not limited to the embodiments described above, but is capable of variation and modification within the scope of the appended claims.

We claim:

1. A procedure to simplify the administration and handling of several companies' ID cards granting entitlements, containing the personified data of the respective user, comprising use of a web platform which communicates with the companies for this, wherein the points of acceptance for the cards are equipped with reading devices to read RFID and/or NFC data carriers, comprising the following steps:
the user obtains a visually readable unique user identification number (UIN) and at least one data carrier readable with RFID and/or NFC reading devices containing a data carrier identification number (UIN) which is uniquely linked on the web platform with the visually readable user identification number (UIN);
on the web platform the user opens an account under the visually readable user identification number (UIN) and enters the company denomination and the card data into the account;
through the web platform the company is notified of the user's data carrier identification number (UIN);
the user's data carrier identification number (UIN) is included in the respective company's authentication system and transferred to the respective company's reading device(s) for the reading of RFID or NFC data carriers and linked with the entitlements granted by the card.

2. The procedure according to claim 1, wherein the visually readable user identification number (UIN) is uniquely linked on the web platform with two or more data carriers that can be read with RFID and/or NFC reading devices.

3. The procedure according to claim 2, wherein the two or more data carriers that can be read with RFID and/or NFC reading devices grant a different entitlement.

4. The procedure according to claim 1, wherein at least one data carrier readable with RFID and/or NFC is connected to an object the user carries with him.

5. The procedure according to claim 2, wherein the object connected to the RFID and/or NFC data carrier is the user's mobile phone or key ring.

6. The procedure according to claim 5, wherein the mobile phone's protective cover is equipped with the data carrier and/or the data carrier is fixed to the mobile phone shell.

7. The procedure according to claim 1, wherein the user obtains the visually readable identification number (UIN) with a cover preventing third parties from seeing it.

8. The procedure according to claim 1, wherein the point of acceptance has at least one till equipped as a reading device to read RFID and/or NFC data carriers.

9. The procedure according to claim 1, wherein the reading device to read RFID and/or NFC data carriers consists of at least one mobile phone of the point of acceptance.

10. The procedure according to claim 1, wherein the user applies for another company's card with his visually readable user identification number (UIN) and his account at the web platform, and that the web platform notifies the other company of the user's data carrier identification number(s) (UIN) uniquely linked with the visually readable identification number (UIN).
